(19) United States
(12) Patent Application Publication
(10) Pub. No.: US 2006/0116079 A1
(43) Pub. Date: Jun. 1, 2006

(54) Communication apparatus, communication system, and communication control method

(75) Inventor: Kazuya Fukushima, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/288,129

(22) Filed: Nov. 29, 2005

(30) Foreign Application Priority Data
Nov. 30, 2004 (JP) 2004-347159

(51) Int. Cl. H04B 17/00

(52) U.S. Cl. 455/62; 455/67.11

(57) ABSTRACT

A communication apparatus performs wireless communication with at least one external communication apparatus through a channel corresponding to a certain frequency band. The communication apparatus includes a storage unit and a control unit. The storage unit stores information including a plurality of combinations of channels that are at least certain frequencies apart from one another. The control unit selects a combination of channels from the plurality of combinations of channels stored in the storage unit in accordance with wireless communication environment, and respectively allocates the channels of the selected combination to the communication apparatus and the at least one external communication apparatus.

### CROSS-REFERENCE TO RELATED APPLICATIONS

This application is based upon and claims the benefit of priority from prior Japanese Patent Application No. 2004-347159, filed Nov. 30, 2004, the entire contents of which are incorporated herein by reference.

### BACKGROUND

1. Field

The present invention relates to a communication apparatus, a communication system, and a communication control method, which allow wireless communications.

2. Description of the Related Art

An access point is known as a communication apparatus, which connects between a terminal, such as a personal computer (PC), and a network. Wireless communication between a terminal and an access point is performed via, for example, a wireless local area network (LAN). In this case, the access point achieves wireless communication with the terminal through a channel corresponding to a certain frequency band. In a system having a plurality of access points as described above, it is necessary to allocate channels to the access points such that each access point may not be easily influenced by radio interference. The radio interference causes a reduction in throughput.

For example, Jpn. Pat. Appln. KOKAI Publication No. 2004-96148 discloses a method for allocating optimum channels to the respective access points to prevent radio interference. According to this publication, a master access point sends an access point an instruction to transmit a test radio wave. The access point, which receives the instruction, transmits a test radio wave. The access points, other than the access point that transmitted the test radio wave, receive the test radio wave. The master access point obtains and analyzes status of reception of the test radio wave received by each of the access points. Then, the master access point determines the channels to be allocated to the respective access points.

However, according to the technique disclosed in the above publication, each time the channels are to be allocated to the access points, a test radio wave is transmitted between the access points, and the master access point analyzes status of reception. The combinations of channels to be used by the respective access points can be determined only after the analysis. Therefore, it takes a long time to determine the combinations of the channels, and inconvenience is liable to occur during the process. This method cannot quickly and flexibly switch the allocation of the channel upon change of radio wave environment.

Under those circumstances, there is a demand for a technique to reduce inconvenience relating to radio wave transmitted between communication apparatuses.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing a communication system according to an embodiment of the present invention;

FIG. 2 is a block diagram showing a configuration common to the access points shown in FIG. 1;

FIG. 3 is a block diagram showing functional configurations of the host access point shown in FIG. 1;

FIG. 4 is a diagram showing a channel combination candidate table;

FIG. 5 is a diagram showing a channel combination set table;

FIG. 6 is a diagram showing a setting screen, which allows a user to change a setting of the contents of the channel combination set table;

FIG. 7 is a schematic diagram showing a format of a communication packet transmitted between access points;

FIG. 8 is a flowchart showing an operation of the host access point and an operation of the non-host access points;

FIG. 9 is a schematic diagram showing a communication system which solves the problems of both radio interference and radio intensity;

FIG. 10 is a block diagram showing functional configurations of the host access point shown in FIG. 9; and

FIG. 11 is a flowchart showing an operation of the host access point and an operation of the non-host access points shown in FIG. 9.

### DETAILED DESCRIPTION

Embodiments of the present invention will be described with reference to the accompanying drawings.

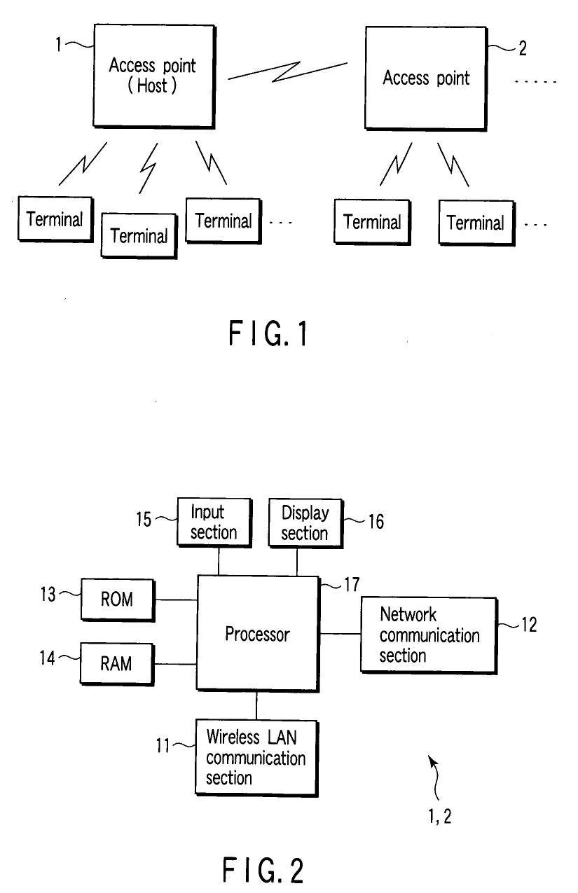

FIG. 1 is a schematic diagram showing a communication system according to an embodiment of the present invention.

The system includes an access point 1, which serves as a host, and one or a plurality of access points (non-host access points) 2, which do not serve as hosts. In this embodiment, it is assumed that the system includes a plurality of access points 2.

Each of the access points is a communication apparatus capable of performing wireless communications with terminals (electronic apparatuses, such as personal computers and PDAs) via a wireless LAN using a channel corresponding to a certain frequency band. In addition, it can connect the terminals with other wireless communication media or wired communication media (the Internet, LANs, etc.), which are not shown. The respective access points use channels corresponding to different frequency bands. In particular, the respective access points use channels corresponding to at least certain frequencies apart from one another, so that the access points may not be easily influenced by radio interference. For example, Ch. 1 to Ch. 14 are available in this embodiment.

If the access point 1 is unable to function as the host (for example, if it is not supplied with power on or any trouble occurs), any one of the access points 2 may detect that situation and operate as a host in place of the access point 1. This embodiment is an example in which the access point 1 always operates as the host.

FIG. 2 is a block diagram showing a configuration common to the access points shown in FIG. 1.

Each of the access points 1 and 2 includes a wireless LAN communication section 11, a network communication section 12, a read only memory (ROM) 13, a random access memory (RAM) 14, an input section 15, a display section 16 and a processor 17.

The wireless LAN communication section 11 performs wireless communications via a wireless LAN with terminals and other access points, which exist within the coverage of radio waves. The network communication section 12 performs communication with other communication media, such as the Internet and LANs (not shown).

The ROM 13 stores a control program and various tables which the processor 17 uses. The RAM 14 is used as a workspace of the processor 17. While the access point is operating, the control program and the tables, which the processor 17 uses, reside in the RAM 14.

The input section 15 is used to carry out operations, such as turning on power and resetting. The output level of a radio wave, which the access point transmits, can be varied by operating the input section 15. The system may be constructed such that the output level can be varied by operating a terminal wirelessly connected to the access point. The display section 16 displays status of the access point, etc.

The processor 17 executes the overall operations of the access point. For example, it executes communication with other access points and internal process (management of the tables, etc.) in accordance with the control program or the like.

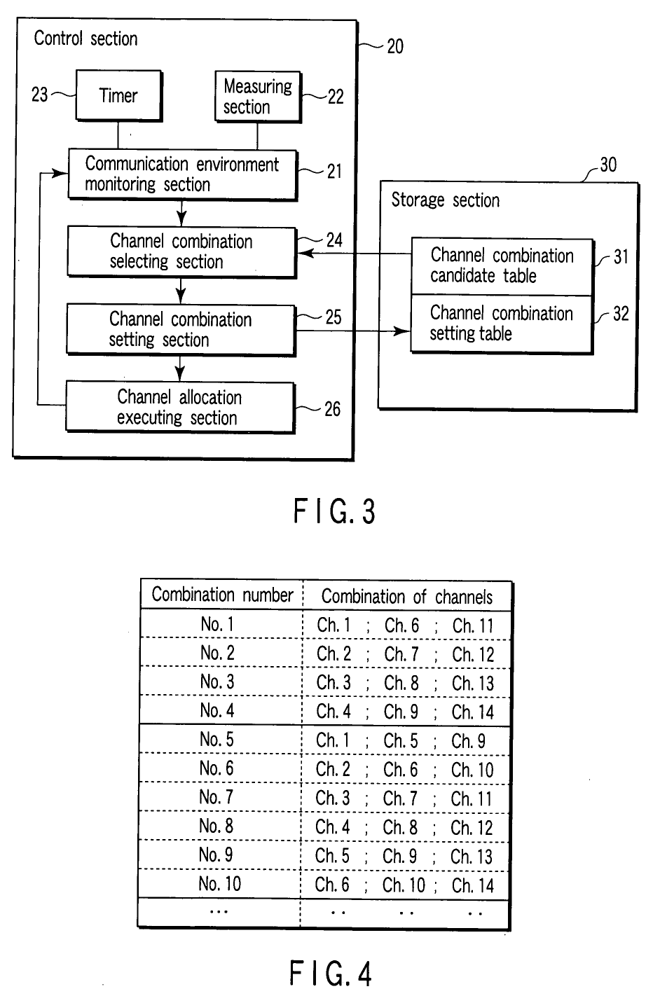

FIG. 3 is a block diagram showing functional configurations of the host access point 1 shown in FIG. 1.

A control section 20 is implemented by the processor 17 (FIG. 2), which executes the control program. The controls section 20 includes a communication environment monitoring section 21, a measuring section 22, a timer 23, a channel combination selecting section 24, a channel combination setting section 25, a channel allocation executing section 26. A storage section 30 is implemented by the RAM 14 (FIG. 2), which stores the tables. The storage section 30 includes a channel combination candidate table 31 and a channel combination setting table 32.

The communication environment monitoring section 21 monitors an ambient communication environment (especially radio wave environment), at certain time intervals, during initial operations (e.g., when the access point 1 is powered on or reset) or while the access point 1 is operating. For example, it can monitor the load of the system based on the number of the access points 2, which constitute the communication system together with the access point 1. It can also monitor the bit error rate or throughput of wireless communication at the access point 1 and the change in reception level of a wirelessly transmitted radio wave received by the access point 1. If the monitored value is greater (or smaller) than a reference value, the communication environment monitoring section 21 can detect that. If a parameter value exceeds a threshold value during the initial operation or while the access point 1 is operating, the communication environment monitoring section 21 activates the channel combination selecting section 24. For example, if the bit error rate of wireless communication exceeds a predetermined value, the communication environment monitoring section 21 determines that it is necessary to change the combination of the channels allocated to the access points 2, and activates the channel combination selecting section 24.

The measuring section 22 measures a bit error rate, throughput and reception level of a radio wave. The timer 21 measures a time interval between monitoring processes in the communication environment monitoring section 21.

The channel combination selecting section 24 selects a combination of channels (a combination of channel numbers) from the candidates of a plurality of combinations of channels written in the channel combination candidate table 31 (to be described later), in accordance with the current communication environment (especially the radio wave environment). If it is necessary to change the combination of the current channels, the channel combination selecting section 24 may refer to the channel combination setting table 32 (to be described later) showing the current combination of the channels.

The channel combination setting section 25 allocates the channels of the combination, which has been selected by the channel combination selecting section 24, respectively to the access point 1 and the other access point 2, and registers the combination on the channel combination setting table 32. The channel combination setting section 25 allows the user to change the setting of the contents of the channel combination setting table 32 (the combination of the channels, the channel numbers respectively allocated to the access points, etc.) through the display section and the input section of the terminal wirelessly connected thereto (user interface).

The channel allocation executing section 26 notifies the respective access points, to which channels are allocated by the channel combination setting section 25, of the corresponding channel numbers through, for example, wireless communication. In this time, if the wireless communication is disabled for some reason, the respective access points may be notified of the channel numbers through wired communication (such as a wired LAN). As a result, the access points notified of the channel numbers can perform wireless communication with terminals through the channels. The access point 1 can also perform wireless communication with terminals through the allocated channels. When the process of allocating channels is completed, the channel allocation executing section 26 notifies the communication environment monitoring section 21 of the completion.

With the above configuration, the control section 20 monitors the wireless communication environment at certain time intervals after the access point 1 is activated. Based on the monitor result, the control section 20 dynamically changes the combination of the channels allocated to the access point 1 and the other access points 2.

The channel combination candidate table 31 is used in a process of selecting a channel combination in the channel combination selecting section 24. The table 31 contains information including a plurality of combinations of channels, which are at least certain frequencies apart from one another. FIG. 4 shows an example of the channel combination candidate table 31.

In the example of FIG. 4, each of the combinations of channels of the combination numbers 1 to 4 has a group of three channel numbers. There is a bandwidth, which corresponds to four channels, between two of the three channels. The bandwidth is sufficient to avoid influence of radio interference. Each of the combinations of channels of the combination numbers 5 to 10 also has a group of three channel numbers. There is a bandwidth, which corresponds to three channels, between two of the three channels. Although the bandwidth is smaller than the four channels, it is sufficient to avoid influence of radio interference. Whichever candidate is selected, the communication will not be easily influenced by radio interference.

In the table shown in FIG. 4, every combination has three channels. However, the present invention is not limited to this example. For example, a combination of two channels or four channels may be added to the table.

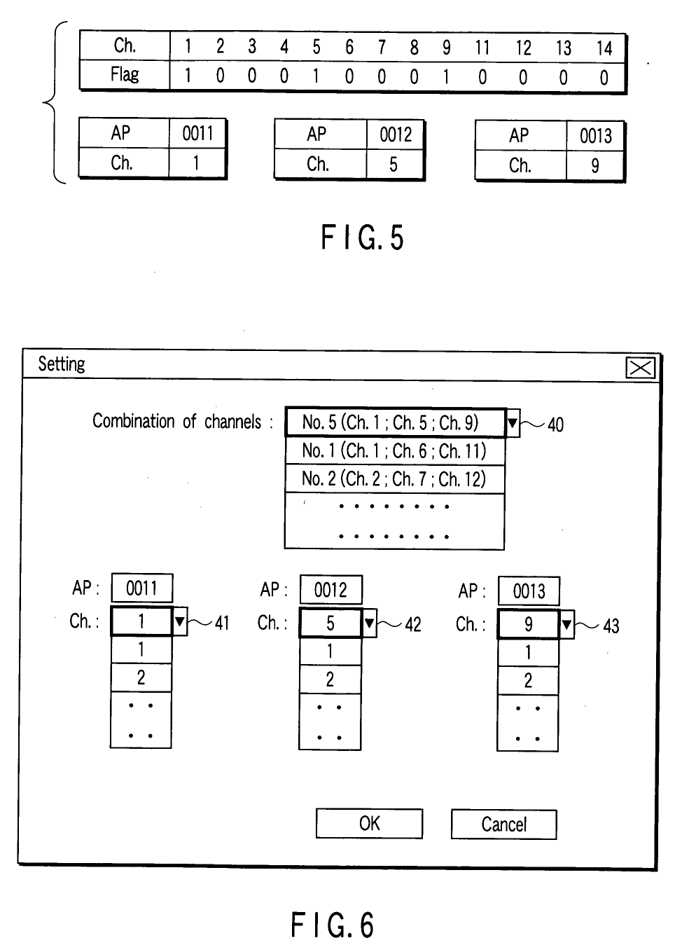

The channel combination setting table 32 is used in a setting process in the channel combination setting section 25. The table 32 contains information on the channels of the selected combination, information on IDs of the access points to which the respective channels are allocated, etc. FIG. 5 shows an example of the channel combination setting table 32.

In the example shown in FIG. 5, the channels selected from all channels Ch. 1 to Ch. 14 are flagged. For example, if the combination No. 5 (Ch. 1, Ch. 5 and Ch. 9) is selected from the table shown FIG. 4, a flag “1” is set to Ch. 1, Ch. 5 and Ch. 9 in the table of FIG. 5, while a flag “0” is set to the other channels. Further, in the table shown in FIG. 5, “0011”, “0012” and “0013” are indicated as IDs of the three access points respectively allocated to the selected channels Ch. 1, Ch. 5 and Ch. 9.

FIG. 6 is a diagram showing an example of the setting screen, which allows a user to change a setting of the contents of the channel combination set table 32.

In the example shown in FIG. 6, the setting screen includes a field 40 to designate a combination of channels, and fields 41, 42 and 43 to designate channel numbers allocated to the respective access points. Each of the fields display information selected and set by the above-described selecting and setting processes as defaults. The user can designate any one of the combinations of channels from a plurality of candidates in the field 40. The user can also add a new combination of channels as a candidate to the field 40, or delete an unnecessary candidate from the field 40. Further, the user can designate any channel number from a plurality of candidates in each of the fields 41 to 43.

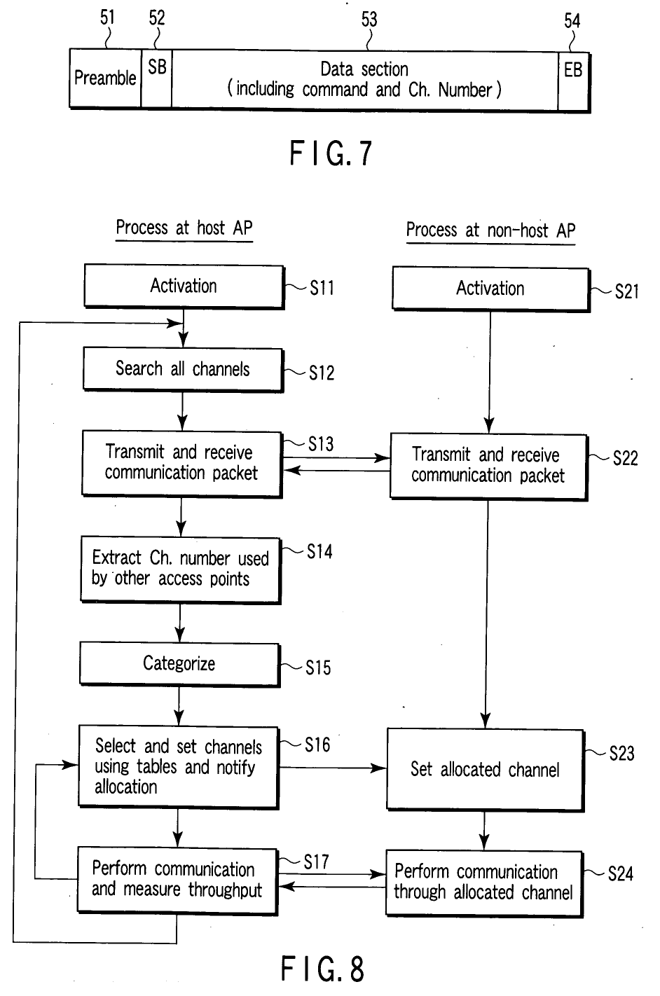

FIG. 7 is a schematic diagram showing a format of a communication packet transmitted between access points.

The communication packet has a preamble 51, a start bit (SB) 52, a data section 53 and an end bit (EB) 54. The preamble 51 corresponds to the header of the communication packet, and includes information such as a destination address, a source address and a data length. The start bit 52 indicates the start position of the data section 53. The data section 53 constitutes a main body of the communication packet. The data section 53 includes a command for the destination. It may include information designating a channel number to be used in the destination and information indicative of an amount of transmission output from the destination to be lowered. The end bit 54 shows the position of the end of the data section 53.

An operation of the host access point 1 and an operation of the non-host access points 2 will now be described with reference to FIG. 8. Although FIG. 8 shows only one non-host access point 2, it is assumed that there are a plurality of non-host access points 2.

The access point 1 and the access points 2 are activated (steps S11 and S21). Then, the access point 1 searches all channels (Ch. 1 to Ch. 14) when starting wireless communication by a wireless LAN. Then, the access point 1 performs wireless communication with the access points 2 existing in a range in which wireless communication is possible, and obtains necessary information by exchange of communication packets (steps S12 and S13). In this time, each of the access points 2 transmits to the access point 1 a communication packet including its ESS ID, the channel number and the throughput thereof (step S22).

Upon receipt of the communication packets from the access points 2, the access point 1 extracts information such as the ESS ID and the channel number used by each of the access points 2 (step S14). Based on the information such as the ESS ID, the access point 1 identifies a group of the access points 2 which use the same domain, and categorize them as the same category (step S15).

The access point 1 selects a combination of channels, which is close to the channels used by these access points 2, from the candidates for a plurality of combinations of channels written in the channel combination candidate table 31. Then, the access point 1 sets the selected combination in the channel combination setting table 32. Thereafter, it transmits to the access points 2 a channel change command including the channel numbers respectively allocated to the access points 2 (step S16).

Each of the access points 2, which receives the channel change command, performs a setting process so that it can perform wireless communication through the allocated channel (step S23). The access point 2 executes wireless communication with terminals through the allocated channel (step S24).

The access point 1 also executes wireless communication with terminals through the channel allocated to itself. The access point 1 measures a throughput by communication with the access points 2 (step S17). If the throughput does not reach a predetermined value, the access point 1 determines that the combination of channels need be changed, and repeats the process of the step S16. On the other hand, if the throughput reaches the predetermined value, the access point 1 determines that the combination of channels is proper, and completes the process of allocating channels.

During the operation of the access point 1, the processes from the steps S12 to S17 are repeated at regular intervals.

The above description relates to a method for avoiding influence by radio interference between access points. Conventionally, in addition to the aforementioned problem of radio interference that occurs between access points, there has been a problem in the case where the distance between the access points is short and the output level of the radio wave wirelessly transmitted from the transmission side is too high. That is, the reception side cannot properly perform a reception process in that case, because the radio wave received by the reception side is too intense. For example, if the level of the radio wave received by the reception side exceeds the upper limit of the permissible range, saturation occurs in a low noise amplifier (LNA) of an RF circuit, the reception process cannot be performed properly. In the following, a system to solve the problem of the radio intensity, as well as the aforementioned problem of radio interference, will be described.

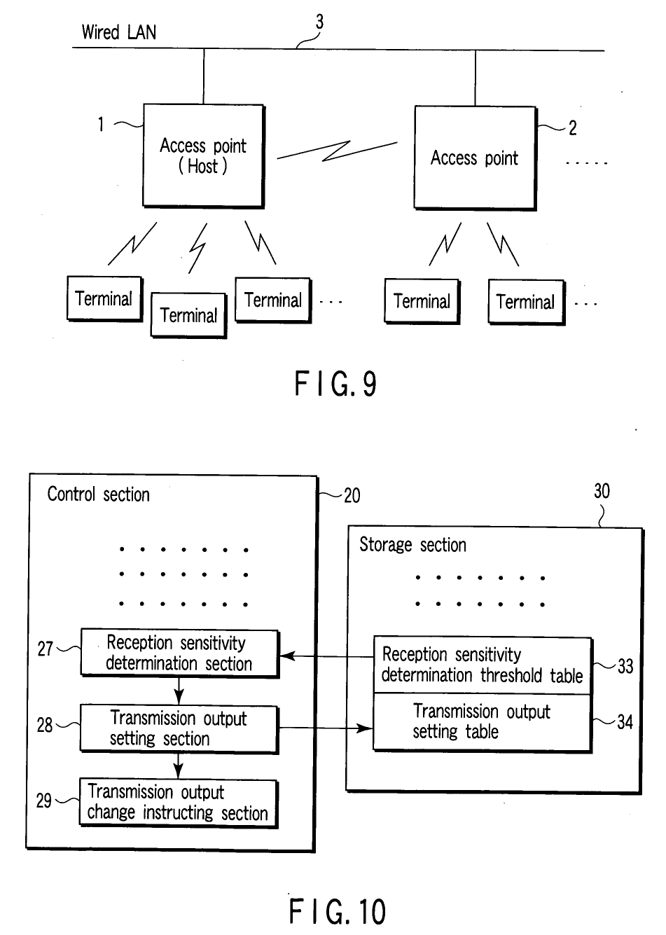

FIG. 9 is a schematic diagram showing a communication system, which solves the problems of both the radio interference and the radio intensity. The elements common to FIGS. 1 and 9 are identified by the same reference numerals.

The system shown in FIG. 9 is different from the system shown in FIG. 1 in that a wired LAN (e.g., backbone LAN) is additionally included. When a radio wave wirelessly transmitted to the access point 1 from the access point 2 has a reception level higher than a predetermined value, the access point 1 transmits a command to lower the output level of the radio wave to the corresponding access point 2 through the wired LAN 3.

FIG. 10 is a block diagram showing functional configurations of the host access point 1 shown in FIG. 9.

The control section 20 shown in FIG. 10 includes a reception sensitivity determination section 27, a transmission output setting section 28 and a transmission output change instructing section 29, in addition to the elements 21 to 26 shown in FIG. 3. The storage section 30 shown in FIG. 10 includes a reception sensitivity threshold table 33 and a transmission output setting table 34, in addition to the elements 31 and 32 shown in FIG. 3.

The reception sensitivity determination section 27 determines whether or not the level of the received radio wave measured by the measuring section 22 (FIG. 3) is too high, with reference to the reception level at the access points 2 obtained through the exchange of communication packets or the upper limit value of the reception permissible level indicated in the reception sensitivity threshold table 33 (to be described later).

When the reception sensitivity determination section 27 determines that the level of the received radio wave is too high, the transmission output setting section 28 determines the amount of change by which the transmission output level of the access point 2 is reduced, and registers the amount in the transmission output setting table 34 (to be described later).

The transmission output change instructing section 29 transmits a predetermined command including the amount of change determined by the transmission output setting section 28 to the corresponding access point 2 through the wired LAN 3, thereby requesting the access point 2 to lower the output level of the radio wave transmitted therefrom.

The reception sensitivity threshold table 33 is a table for use in the determination process in the reception sensitivity determination section 27. It stores threshold values, such as an upper limit value of the reception permissible level at the access point 1.

The transmission output setting table 34 is a table for use in the setting process in the transmission output setting section 28. It stores the amount of change in level of the transmission output, which has been lowered at every access point.

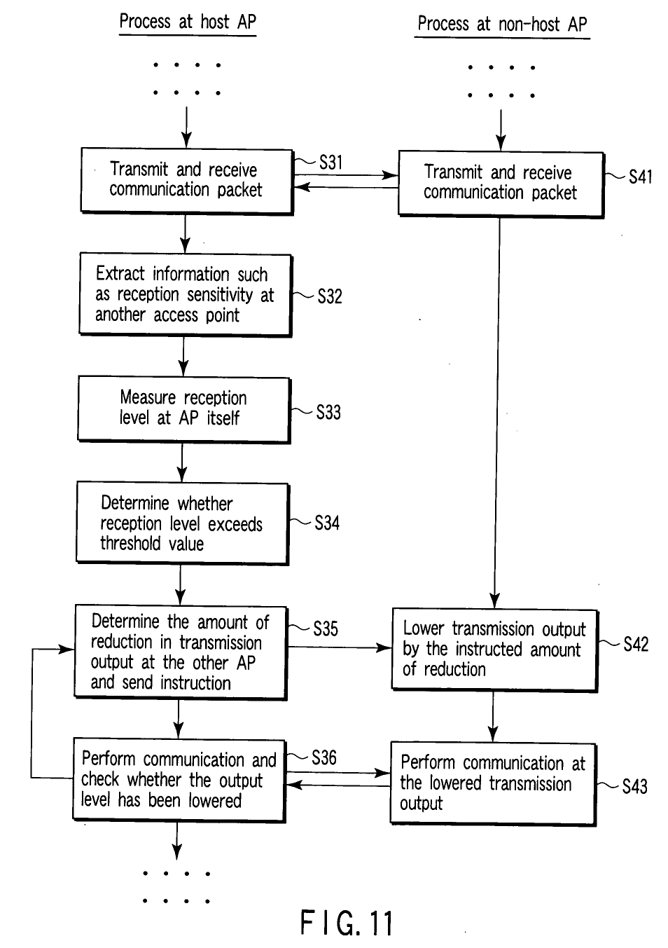

An operation of the host access point 1 and an operation of the non-host access points 2, which are shown in FIG. 9, will be described with reference to FIG. 11. The operations of the host access point 1 and the access point 2 shown in FIG. 11 are performed, for example, in parallel with the operations shown in FIG. 8.

In the operations shown in FIG. 11, the access point 1 and the access points 2 perform transmission and reception of communication packets (steps S31 and S41) in the same manner described above as in the steps S13 and S22 in FIG. 8. The access point 1 transmits, to each access point 2 through the wired LAN 3, a command requesting various information including the reception level of a radio wave wirelessly received by each access point 2. The access point 2 transmits various information including the reception level to the access point 1 in accordance with the command.

The access point 1 extracts the information on the reception level at the access point 2 from the communication packet transmitted from that access point 2 (step S32). Then, the access point 1 compares the reception level at the access point 2 with the reception level at the access point 1. Alternatively, it compares the upper limit value of the reception permissible level indicated in the reception sensitivity threshold table 33 with the reception level at the access point 1. Based on the comparison, the access point 1 determines whether the reception level at the access point 1 exceeds the threshold value or not (whether the reception level is too high or not) (step S34).

If the reception level exceeds the threshold value, the access point 1 determines that the output level of the radio wave wirelessly transmitted from the access point 2 is too high, determines the amount of reduction in level of the output, and performs setting on the transmission output setting table 34. Thereafter, the access point 1 transmits to the access point 2 an output level change command to request lowering the output level of the access point 2 (step S35). This command includes information indicative of the amount of reduction in level of the output.

Upon receipt of the output level change command, the access point 2 lowers the output level by the designated amount of reduction (step S42). The access point 2 performs the wireless communication at the lowered output level (step S43).

The access point 1 measures the level of the received radio wave again, thereby checking whether the output level at the access point 2 has been lowered as requested or not (step S36). If the level of the received radio wave at the access point 1 is still higher than the threshold value, the access point 1 determines that further reduction in output level at the access point 2 is required, and repeats the process in the step S35. If the level of the received radio wave at the access point 1 is not higher than the threshold value, the access point 1 determines that the output level is proper and ends the process of lowering the output level.

Thus, according to the embodiment of the present invention, the radio interference between access points can be reduced, and the throughput can be improved. Moreover, the allocation of the channel can be switched quickly and flexibly upon change of radio wave environment. Furthermore, it is possible to avoid a trouble in the reception process, which may occur when the level of the radio wave received by the access point is too high.

As has been described in detail above, the present invention can reduce inconvenience relating to radio waves transmitted between communication apparatuses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus which performs wireless communication with at least one external communication apparatus through a channel corresponding to a certain frequency band, the communication apparatus comprising:
a storage unit which stores information including a plurality of combinations of channels that are at least certain frequencies apart from one another; and
a control unit, which selects a combination of channels from the plurality of combinations of channels stored in the storage unit in accordance with wireless communication environment, and respectively allocates the channels of the selected combination to the communication apparatus and the at least one external communication apparatus.

2. The communication apparatus according to claim 1, further comprising a wired communication unit, which transmits the selected combination of channels to the at least one external communication apparatus.

3. The communication apparatus according to claim 1, wherein the control unit monitors wireless communication environment, and selects a combination of channels from the plurality of combinations of channels stored in the storage unit in accordance with a result of the monitoring.

4. The communication apparatus according to claim 1, further comprising a wireless communication unit which varies an output level of a radio wave to be wirelessly transmitted.

5. The communication apparatus according to claim 1, wherein when a reception level of a radio wave wirelessly transmitted from one of the at least one external communication apparatus exceeds a predetermined value, the control unit requests the one of the at least one external communication apparatus to lower an output level of the radio wave through a wired communication unit.

6. A communication system which performs wireless communication between a first communication apparatus and a second communication apparatus through a channel corresponding to a certain frequency band, the first communication apparatus comprising:
a storage unit which stores information including a plurality of combinations of channels that are at least certain frequencies apart from one another; and
a control unit, which selects a combination of channels from the plurality of combinations of channels stored in the storage unit in accordance with wireless communication environment, and respectively allocates the channels of the selected combination to the first communication apparatus and the second communication apparatus.

7. The communication system according to claim 6, further comprising a wired communication unit, which transmits the selected combination of channels to the second communication apparatus.

8. The communication system according to claim 6, wherein the control unit monitors wireless communication environment, and selects a combination of channels from the plurality of combinations of channels stored in the storage unit in accordance with a result of the monitoring.

9. The communication system according to claim 6, further comprising a wireless communication unit which varies an output level of a radio wave to be wirelessly transmitted.

10. The communication system according to claim 6, wherein when a reception level of a radio wave wirelessly transmitted from the second communication apparatus exceeds a predetermined value, the control unit requests the second communication apparatus to lower an output level of the radio wave through a wired communication unit.

11. A communication method applied to a communication system which performs wireless communication between a first communication apparatus and a second communication apparatus through a channel corresponding to a certain frequency band, the method comprising:
storing information including a plurality of combinations of channels that are at least certain frequencies apart from one another; and
selecting a combination of channels from the stored plurality of combinations of channels in accordance with wireless communication environment, and respectively allocating the channels of the selected combination to the first communication apparatus and the second communication apparatus.

12. The communication method according to claim 11, further comprising transmitting the selected combination of channels to the second communication apparatus through a wired communication unit.

13. The communication method according to claim 11, further comprising monitoring wireless communication environment in the first communication apparatus, and selecting a combination of channels from the stored plurality of combinations of channels in accordance with a result of the monitoring.

14. The communication method according to claim 11, further comprising varying an output level of a radio wave to be wirelessly transmitted from the first communication apparatus.

15. The communication method according to claim 11, further comprising, when a reception level of a radio wave wirelessly transmitted from the second communication apparatus exceeds a predetermined value, sending a request from the first communication apparatus to the second communication apparatus to lower an output level of the radio wave through a wired communication unit.
